(19) United States
(12) Patent Application Publication
(10) Pub. No.: US 2024/0172800 A1
(43) Pub. Date: May 30, 2024

(54) HEATER ASSEMBLY HAVING A FASTENER

(71) Applicant: Philip Morris Products S.A., Neuchatel (CH)

(72) Inventors: Sébastien CAPELLI, Cernier (CH); Eva SAADE LATORRE, Colombier (CH); Enrico TURRINI, Neuchatel (CH)

(73) Assignee: Philip Morris Products S.A., Neuchatel (CH)

(21) Appl. No.: 18/552,308

(22) PCT Filed: Apr. 1, 2022
(86) PCT No.: PCT/EP2022/058813

§ 371 Date: Sep. 25, 2023

(30) Foreign Application Priority Data
Apr. 1, 2021 (EP) 21166790.2

(51) Int. Cl. A24F 40/46; A24F 40/20; A24F 40/70; H05B 3/46

(52) U.S. Cl. CPC A24F 40/46; A24F 40/20; A24F 40/70; H05B 3/46; H05B 2203/022

(57) ABSTRACT

A heater assembly for an aerosol-generating device is provided, the heater assembly including: a first heater casing including an air inlet; a second heater casing including an aerosol outlet; and a heating chamber configured to heat an aerosol-forming substrate, the heating chamber being in fluid communication with both the air inlet and aerosol outlet to define an airflow pathway through the heater assembly, the heating chamber being arranged between the first and the second heater casings, and the first and the second heater casings are attached to each other by a fastener, the fastener being configured to exert an axial force on the first and the second heater casings to urge axially opposing internal surfaces of the first and the second heater casings into sealing engagement with respective axially opposing end surfaces of the heating chamber to seal the airflow pathway.

The present disclosure relates to a heater assembly for an aerosol-generating device. The present disclosure further relates to an aerosol-generating device comprising a heater assembly. In particular, but not exclusively, the present disclosure relates to a handheld electrically operated aerosol-generating device for heating an aerosol-forming substrate to generate an aerosol and for delivering the aerosol into the mouth of a user. The present invention also relates to an aerosol-generating system comprising an aerosol-generating device and an aerosol-forming substrate.

Aerosol generating devices which heat an aerosol-forming substrate to produce an aerosol without burning the aerosol-forming substrate are known in the art. The aerosol-forming substrate is typically provided within an aerosol-generating article, together with other components such as filters. The aerosol-generating article may have a rod shape for insertion of the aerosol-generating article into a heating chamber of the aerosol-generating device. A heating element is typically arranged in or around the heating chamber for heating the aerosol-forming substrate once the aerosol-generating article is inserted into the heating chamber of the aerosol-generating device.

The heating chamber may be arranged within a housing of the aerosol-generating device and form part of an airflow pathway through the aerosol-generating device. It is known to provide seals around the airflow pathway and between the heating chamber and the housing to seek to prevent aerosol from leaking out of the airflow pathway and into other parts of the aerosol-generating device, which may cause damage to the electronics of the device. The seals may be placed in direct contact with the heating chamber and consequently are generally formed from a heat resistant polymer such as silicone or polysiloxane. However, exposing such polymer seals to the heating temperatures of the heating chamber may generate undesirable by-products which may contaminate the aerosol. Furthermore, such heating temperatures may degrade the seals over time.

To heat the heating chamber, an aerosol-generating device may comprise a flexible heating element arranged around the heating chamber. To allow for direct contact between the seals and the heating chamber and reduce heating of the seals, attempts have been made to distance the seals from the heating element, for example, at a downstream end of the heating chamber. However, this may result in having to compromise on the overall dimensions of the aerosol-generating device, for example, through use of a longer heating chamber, which increases the energy consumption of the heating chamber and reduces the efficiency of the aerosol-generating device. Furthermore, increasing the length of the heating chamber may result in the heating chamber surrounding other components of the aerosol-generating article, such as filters, which may be heated indirectly through heat conduction through the heating chamber. Undesirably, heating of filters wastes energy.

As an alternative to increasing the length of the heating chamber, the length of the heating element surrounding the heating chamber may be decreased. However, this may result in a portion of the aerosol-forming substrate not being covered or surrounded by the heating element such that heat has to travel a longer distance along a length of the heating chamber to heat this portion of the aerosol-forming substrate compared to travelling a relatively short distance through the thickness of the heating chamber wall. Therefore, a portion of the aerosol-forming substrate which is not surrounded by the heating element may be heated less effectively than a portion which is surrounded by the heating element. Consequently, a portion of the aerosol-forming substrate which is not surrounded by the heating element may be at a lower temperature than a portion which is surrounded by the heating element, which may result in aerosol condensing prematurely in the cooler portion. This can result in less aerosol being delivered to a user.

A further disadvantage of using polymer seals between the heating chamber and a housing of the device is that they provide a heat conduction path, which transfers heat away from the heating chamber to the materials surrounding the heating chamber. This lost heat reduces the heat available for heating the aerosol-forming substrate and reduces the efficiency of the aerosol-generating device.

It would be desirable to provide a heater assembly for an aerosol-generating device having improved sealing of its airflow pathway. It would be desirable to provide a heater assembly for an aerosol-generating device which is more energy efficient and improves the delivery of aerosol to a user.

According to an example of the present disclosure, there is provided a heater assembly for an aerosol-generating device. The heater assembly may comprise a first heater casing. The first heater casing may comprise an air inlet. The heater assembly may comprise a second heater casing. The second heater casing may comprise an aerosol outlet. The heater assembly may comprise a heating chamber for heating an aerosol-forming substrate. The heating chamber may be in fluid communication with the air inlet. The heating chamber may be in fluid communication with the aerosol outlet. The heating chamber may be in fluid communication with both the air inlet and the aerosol outlet to define an airflow pathway through the heater assembly. The heating chamber may be arranged between the first and second heater casings. The first and second heater casings may be attached to each other by a fastener. The fastener may be configured to exert an axial force on the first and second heater casings. The fastener may be configured to urge axially opposing internal surfaces of the first and second heater casings into sealing engagement with respective axially opposing end surfaces of the heating chamber to seal the airflow pathway.

According to an example of the present disclosure, there is provided a heater assembly for an aerosol-generating device. The heater assembly comprising a first heater casing comprising an air inlet. The heater assembly comprising a second heater casing comprising an aerosol outlet. The heater assembly comprising a heating chamber for heating an aerosol-forming substrate. The heating chamber being in fluid communication with both the air inlet and aerosol outlet to define an airflow pathway through the heater assembly. The heating chamber is arranged between the first and second heater casings. The first and second heater casings are attached to each other by a fastener, the fastener being configured to exert an axial force on the first and second heater casings to urge axially opposing internal surfaces of the first and second heater casings into sealing engagement with respective axially opposing end surfaces of the heating chamber to seal the airflow pathway.

Advantageously, the above-described example of the present disclosure does not require polymer seals because the airflow pathway is sealed by the direct engagement of the end surfaces of the heating chamber with the internal surfaces of the first and second heating cases. Therefore, the undesirable by-products which may be released by heating of polymer seals cannot occur.

A further advantage of sealing the airflow pathway using the direct engagement of the end surfaces of the heating chamber with the internal surfaces of the first and second heating cases is that space is not required at the ends of the heating chamber to allow for direct contact between the polymer seals and the heating chamber. Any space at one or more ends of the heating chamber, for example, to avoid direct contact between the heating element and the surrounding heater casings, can be significantly reduced. This means that shorter heating chambers can be used and a greater proportion of the length of the heating tube can be heated. This allows for more efficient heating of the aerosol-forming substrate.

Advantageously, the cross-sectional area available for heat conduction away from the heating chamber is considerably reduced. A heating chamber will generally have a wall thickness which is less than the thickness of the polymer seals, for example, 100 microns versus 2 millimetre respectively. Therefore, the area of the end walls of the heating chamber in contact with the first and second heater casings is less than the area of the polymer seals which conventionally surround the heating chamber. Consequently, the amount of heat lost to the parts of the aerosol-generating device surrounding the heating chamber is reduced.

As used herein, the term “axial force” refers to a force which acts in a direction parallel to an axis of the heater assembly. For example, the force may act in a direction parallel to a longitudinal axis of the heater assembly.

As used herein, the terms “distal”, “upstream” “proximal” and “downstream” describe the relative positions of components, or portions of components, of an aerosol-generating device and aerosol generating article. Aerosol generating articles and devices according to the present disclosure have a proximal end through which, in use, an aerosol exits the article or device for delivery to a user, and have an opposing distal end. The proximal end of the aerosol generating article and device may also be referred to as the mouth end. In use, a user draws on the proximal end of the aerosol generating article in order to inhale an aerosol generated by the aerosol generating article or device. The terms upstream and downstream are relative to the direction of aerosol movement through the aerosol generating article or aerosol-generating device when a user draws on the proximal end of the aerosol-generating article. The proximal end of the aerosol-generating article is downstream of the distal end of the aerosol-generating article. The proximal end of the aerosol-generating article may also be referred to as the downstream end of the aerosol-generating article and the distal end of the aerosol-generating article may also be referred to as the upstream end of the aerosol-generating article.

The aerosol outlet may be an opening for receiving an aerosol-generating article. Aerosol may exit the opening via an aerosol-generating article received in the heating chamber.

At least one of the first and second heater casings may comprise an internal cavity. The internal cavity may surround the heating chamber. A length of the heating chamber may be greater than a length of the internal cavity. Advantageously, by making the length of the heating chamber greater than the length of the internal cavity, an elastic deformation is induced in at least one of the first and second heater casings. This elastic deformation is maintained by the fastener and the fastener exerts an axial force on the first and second heater casings to provide sealing engagement between the first and second heater casings and the heating chamber to seal the airflow pathway.

The first heater casing may comprise an internal cavity. The internal cavity may surround the heating chamber. A length of the heating chamber may be greater than a length of the internal cavity.

The second heater casing may comprise an internal cavity. The internal cavity may surround the heating chamber. A length of the heating chamber may be greater than a length of the internal cavity.

The first heater casing may comprise a first internal cavity. The second heater casing may comprise a second internal cavity. The first and second internal cavities may jointly surround the heating chamber. A length of the heating chamber may be greater than the sum of the lengths of the first and second internal cavities.

A length of the heating chamber may be greater than a length of the internal cavity in an unassembled state of the heater assembly.

A length of an internal cavity may include the depth of a recess formed in an internal surface of the internal cavity of at least one of the first and second heater casings. A length of an internal cavity may include the depth of a recess formed in an internal surface of the internal cavity of each of the first and second heater casings.

Alternatively, a length of an internal cavity may solely comprise the length of the internal cavity from a first end of the internal cavity to a second end of the internal cavity of one of the first and second heater casings.

The length of the heating chamber may be about 0.05 percent to about 8.5 percent longer than the internal cavity, preferably about 0.5 percent to 5.0 percent longer than the internal cavity and more preferably about 1.3 percent to about 3.1 percent longer than the internal cavity. These ranges have been found to be suitable for inducing an elastic deformation in at least one of the first and second heater casings.

The length of the heating chamber may be about 0.05 millimetres to about 1.0 millimetres longer than the internal cavity and preferably about 0.2 millimetres to about 0.4 millimetres longer than the internal cavity. These ranges have been found to be suitable for inducing an elastic deformation in at least one of the first and second heater casings.

The first and second heater casings may enclose the heating chamber.

At least one of the first and second heater casings may comprise a material having a tensile or Young's modulus of less than 6 gigapascals, preferably less than 5 gigapascals and more preferably less than 4 gigapascals. These values of tensile modulus are typically less than the tensile modulus of the material of the heater chamber which means that at least one of the first and second heater casings will elastically deform in preference to the heating chamber because the heating chamber is made from stiffer materials than the first and second heater casings. These values of tensile modulus have also been found to provide for a suitable amount of elastic deformation.

The heater chamber may comprise a material having a tensile or Young's modulus of greater than about 100 gigapascals, preferably greater than about 150 gigapascals and more preferably about 190 gigapascals or more. The heater chamber may comprise a material having a tensile or Young's modulus between about 100 gigapascals and about 250 gigapascals, preferably between about 150 gigapascals and about 220 gigapascals and more preferably between about 190 gigapascals and about 205 gigapascals.

At least one of the first and second heater casings may comprise a material having a glass transition temperature of greater than 130 degrees centigrade. At least one of the first and second heater casings may comprise a material having a melting temperature of greater than 280 degrees centigrade. These properties help the material maintain its structural stability at the temperatures experienced during heating and helps to reduce the likelihood of undesirable by-products being produced.

At least one of the first and second heater casings may comprise a material having a Shore hardness of less than 90 A, as determined by technical standard ISO868 Type A.

Preferably, at least one of the first and second heater casings may comprise a material that can be injection moulded.

At least one of the first and second heater casings may comprise a polymer. Polymers have been found to be particular suitable materials due to their elastic properties.

The first and second heater casings may comprise any suitable material or combination of materials. Examples of suitable materials include plastics or composite materials containing one or more materials, or thermoplastics that are suitable for food or pharmaceutical applications, for example polypropylene, polyetheretherketone (PEEK), polyphenylsulfone (PPSU) and polyethylene. Preferably, at least one of the first and second heater casing comprises PEEK or PPSU.

At least one of the first and second heater casings may comprise a chamfer or sloping edge arranged at an internal surface of the at least one of the first and second heater casings for axially aligning the heating chamber. Advantageously, the chamfer or sloping edge helps to accurately locate the heating chamber within the first and second heater casings.

The fastener may comprise a threaded fastener or a snap-fit fastener. These have been found to be suitable types of fastener for attaching the first and second heater casings together. A snap-fit fastener or connector has been found to have a number of further advantages. For example, a snap-fit fastener may help to reduce the dimensions of the heater assembly because it has a reduced profile compared to other types of fastener. A snap-fit fastener may also help to achieve balanced alignment of the first and second heater casings because it applies a constant amount of axial force which cannot be varied. Furthermore, snap-fit fasteners help to simplify manufacture because they only require a single press-fit operation to attach the first and second heater casings. In addition, a snap-fit fastener can be formed integrally with the first and second heater casings to reduce the number of parts required for attachment.

The heater assembly may comprise a plurality of fasteners. The first and second heater casings may be attached to each other by a plurality of fasteners. The plurality of fasteners may be symmetrically spaced around an outer perimeter or external surface of the first and second heater casings. This arrangement helps to apply a constant pressure between the end surfaces of the first and second heater casings which are in contact with each other around the entire perimeter of the first and second heater casings. As a result of this constant pressure, a constant sealing pressure is created between the contact surfaces of the heating chamber and the first and second heater casings around the entire circumference of the tubular heating chamber to provide improved sealing. The heater assembly may comprise at least two fasteners arranged diametrically opposite one another.

The first and second heater casings may be radially spaced from the heating chamber to define a hollow airspace around the heating chamber. Advantageously, the hollow airspace helps to thermally insulate the heating chamber which helps to reduce heat losses from the heating chamber and also helps to reduce heat transfer to an exterior of the heater assembly.

The first heater casing may have an airflow channel. The airflow channel of the first heater casing may be in fluid communication with the air inlet. The second heater casing may have an airflow channel. The airflow channel of the second heater casing may be in fluid communication with the aerosol outlet. The heating chamber may have an airflow channel. The airflow channel of the heating chamber may pass through the length of the heating chamber. The airflow channels of each of the first heating casing, second heater casing and the heating chamber may be in fluid communication with each other to define the airflow pathway through the heater assembly.

The heating chamber may comprise a tubular heating chamber. A diameter of the tubular heating chamber at a first end of the tubular heating chamber may be greater than a diameter along the length of the tubular heating chamber. A diameter of the tubular heating chamber at a second end of the tubular heating chamber may be greater than a diameter along the length of the tubular heating chamber. A diameter of the tubular heating chamber at each end of the tubular heating chamber may be greater than a diameter in a region between the two ends of the tubular heating chamber.

Advantageously, making the diameter of one or both ends of the tubular heating chamber greater than the diameter of the tubular heating chamber along the length of the heating chamber, for example, in the region between the two ends of the tubular heating chamber, allows for greater manufacturing tolerances for the heating chamber and also for the other components of the heater assembly. In particular, it allows for greater radial or lateral tolerances. As used herein, the terms “radial tolerance” or “lateral tolerance” are used to describe manufacturing tolerances in a direction substantially perpendicular to the main longitudinal axis or length of the heater assembly or aerosol-generating device, for example, tolerances which result in components being wider or narrower than their specified design width or diameters being greater or less than their specified design diameter. Radial or lateral tolerances are sometimes referred to as “horizontal tolerances”.

Advantageously, by making an end diameter of the tubular heating chamber greater than other parts of the tubular heating chamber, the internal diameter at one or both ends of the tubular heating chamber will be greater than the internal diameter of the airflow pathway in other components of the heater assembly that the tubular heating chamber engages, that is, the first and second heater casings. This helps to avoid an end surface of the tubular heating chamber protruding or encroaching into the internal space of the airflow pathway, which can potentially cause damage to the aerosol-generating article when it is received into the heating chamber via the airflow pathway and may leave less end surface of the tubular heating chamber to provide sealing engagement with other components. This arrangement also allows for greater radial or lateral tolerances in the other components, which is described in more detail below.

An external diameter of one or both ends of the tubular heating chamber may be up to 20 percent larger, preferably up to 15 percent larger, more preferably up to 12 percent larger, and even more preferably up to 8 percent larger than an external diameter of a portion of the tubular heating chamber between the two ends of the tubular heating chamber. The external diameter of one or both ends of the tubular heating chamber may be between 1 percent and 20 percent larger, between 1 percent and 15 percent larger, between 1 percent and 12 percent larger, or between 1 percent and 8 percent larger than an external diameter of a portion of the tubular heating chamber between the two ends of the tubular heating chamber.

One or both ends of the tubular heating chamber may have an external diameter of between 7.5 millimetres and 9.0 millimetres, preferably between 8.0 millimetres and 8.5 millimetres and more preferably about 8.4 millimetres. A portion of the tubular heating chamber between the two ends of the tubular heating chamber may have an external diameter of between 6.5 millimetres and 8.0 millimetres, preferably between 7.0 millimetres and 8.0 millimetres and more preferably about 7.5 millimetres.

An internal diameter of the heating chamber may substantially correspond, or be substantially equal, to an external diameter of an aerosol-generating article. In some embodiments, an internal diameter of the heating chamber may be slightly smaller than the external diameter of an aerosol-generating article, such that the aerosol-generating article is compressed in the heating chamber. For example, the external diameter of an aerosol-generating article may be about 7.4 millimetres, and the internal diameter of the heating chamber may be about 7.3 millimetres. A length of the heating chamber may substantially correspond, or be substantially equal, to a length of an aerosol-forming substrate provided in an aerosol-generating article.

At least one end portion of the tubular heating chamber may be flared or funnel-shaped. A portion of the tubular heating chamber at both ends of the tubular heating chamber may be flared or funnel-shaped. The axial length of a flared or funnel-shaped end portion of the tubular heating chamber may be between 0.5 percent and 10 percent of the overall length of the tubular heating chamber, preferably between 1 percent and 5 percent of the overall length of the tubular heating chamber and more preferably about 3.3 percent of the overall length of the tubular heating chamber.

The axial length of a flared or funnel-shaped end portion of the tubular heating chamber may be between 0.2 millimetres and 2 millimetres, preferably between 0.4 millimetres and 1 millimetre and more preferably about 0.5 mm. The flared or funnel-shaped end portion or end portions of the tubular heating chamber may be arranged at an angle between 30 and 60 degrees, between 40 and 50 degrees, or at an angle of about 45 degrees to the longitudinal axis of the heating chamber or heater assembly. In some preferred embodiments, the flared or funnel-shaped end portion or end portions of the tubular heating chamber may be arranged at an angle of less than 50 degrees, preferably less than 40 degrees, or more preferably less than 30 degrees to the longitudinal axis of the heating chamber or heater assembly. Advantageously, providing the flared or funnel-shaped end portion or end portions of the tubular heating chamber at an angle of less than 30 degrees to the longitudinal axis of the heating chamber or heater assembly may provide optimal rigidity for the flared or funnel-shaped end portion or end portions of the tubular heating chamber in the direction of the longitudinal axis of the heating chamber or heater assembly.

At least one end or end portion of the tubular heating chamber may have a stepped profile or be joggled. A portion of the tubular heating chamber at both ends of the tubular heating chamber may have a stepped profile or be joggled. The axial length of a stepped or joggled end portion of the tubular heating chamber may be between 0.5 percent and 10 percent of the overall length of the tubular heating chamber, preferably between 1 percent and 5 percent of the overall length of the tubular heating chamber and more preferably about 3.7 percent of the overall length of the tubular heating chamber. Preferably, a radius is provided between the stepped or joggled portions to avoid sharp edges and stress concentrators.

The axial length of a flared or funnel-shaped end portion of the tubular heating chamber may be between 0.2 millimetres and 2 millimetres, preferably between 0.4 millimetres and 1 millimetre and more preferably about 0.5 mm.

The tubular heating chamber may have a tubular wall thickness of between 0.05 millimetres and 1.00 millimetres, preferably between 0.05 millimetres and 0.50 millimetres and more preferably about 0.10 millimetres.

The heating chamber may be made from any suitable material including, but not limited to, a ceramic or metal or metal alloy. An example of a suitable material is stainless steel.

The heater assembly may comprise at least one electric heating element for heating an aerosol-forming substrate. The heater assembly may comprise a plurality of electric heating elements. The electric heating element or elements may be arranged around or circumscribe an external surface of the heating chamber. The electric heating element or elements may be arranged around or circumscribe an internal surface of the heating chamber. The electric heating element or elements may be part of, or integral to, the heating chamber.

The electric heating element or elements may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium- titanium- zirconium-, hafnium-, niobium-, molybdenum-, tantalum-, tungsten-, tin-, gallium-, manganese-, gold- and iron-containing alloys, and super-alloys based on nickel, iron, cobalt, stainless steel, Timetal™, Kanthal™ and other iron-chromium-aluminium alloys, and iron-manganese-aluminium based alloys. In composite materials, the electrically resistive material may optionally be embedded in, encapsulated or coated with an insulating material or vice-versa, depending on the kinetics of energy transfer and the external physicochemical properties required.

The one or more heating elements may be formed using a metal or metal alloy having a defined relationship between temperature and resistivity. Heating elements formed in this manner may be used to both heat and monitor the temperature of the heating element during operation.

The heating element may be deposited in or on a rigid carrier material or substrate. The heating element may be deposited in or on a flexible carrier material or substrate. The heating element may be formed as a track on a suitable insulating material, such as ceramic or glass or polyimide film. The heating element may be sandwiched between two insulating materials.

The heater assembly may comprise a flexible heating element arranged around or circumscribing an external surface of the heating chamber. The flexible heating element may have a length substantially equal to the length of the aerosol-forming substrate provided in the aerosol-generating article. The heating chamber may be longer than the heating element. The heating chamber may have at least one end portion which is not covered or circumscribed by the heating element. An end portion may be provided at both ends of the heating chamber which is not covered or circumscribed by the heating element. The end portion or portions may act as spacer portions to prevent direct contact between the heating element and other components of the heater assembly. The end portion or portions may each have a length of less than 2 millimetres, preferably less than 1 millimetre and preferably about 0.5 millimetres. Advantageously, the spacer portions will be at a lower temperature during heating than the portion of the heating chamber covered or circumscribed by the heating element. The spacer portions may comprise the funnel-shaped end portions or the stepped end portions.

The heating chamber may be configured to receive at least a portion of an aerosol-generating article (as defined below).

According to an example of the present disclosure, there is provided an aerosol-generating device. The aerosol-generating device may comprise a heater assembly according to any of the heater assemblies described above. The aerosol-generating device may comprise a power supply or power source for supplying electrical power to the heater assembly.

According to an example of the present disclosure, there is provided an aerosol-generating device. The aerosol-generating device comprises a heater assembly according to any of the heater assemblies described above and a power supply or power source for supplying electrical power to the heater assembly.

The power supply may be any suitable power supply, for example a DC voltage source. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate or a Lithium-Polymer battery.

The aerosol-generating device is preferably a handheld aerosol-generating device that is comfortable for a user to hold between the fingers of a single hand.

The aerosol-generating device may further comprise control circuitry configured to control a supply of electrical power to the heater assembly. The control circuitry may comprise a microprocessor. The microprocessor may be a programmable microprocessor, a microcontroller, or an application specific integrated chip (ASIC) or other electronic circuitry capable of providing control. The control circuitry may comprise further electronic components. For example, in some embodiments, the control circuitry may comprise any of: sensors, switches, display elements. Power may be supplied to the heater assembly continuously following activation of the device or may be supplied intermittently, such as on a puff-by-puff basis. The power may be supplied to the heater assembly in the form of pulses of electrical current, for example, by means of pulse width modulation (PWM).

The aerosol-generating device may comprise a device housing. The device housing may contain the heater assembly, power supply and control circuitry. The housing may comprise an opening for receiving an aerosol-generating article. The opening may be connected to the aerosol outlet of the second heater casing of the heater assembly to allow for insertion of an aerosol-generating article into the heating chamber. The housing may comprising an air inlet. The air inlet may be connected to the air inlet of the first heater casing of the heater assembly.

The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

According to an example of the present disclosure, there is provided an aerosol-generating system comprising an aerosol-generating device according to any of the examples described above. The aerosol-generating system may comprise an aerosol-generating article comprising an aerosol-forming substrate.

According to an example of the present disclosure, there is provided an aerosol-generating system comprising: an aerosol-generating device according to any of the examples described above; and an aerosol-generating article comprising an aerosol-forming substrate.

As used herein, the term “aerosol-generating article” refers to an article comprising an aerosol-forming substrate that, when heated in an aerosol-generating device, releases volatile compounds that can form an aerosol. An aerosol-generating article is separate from and configured for combination with an aerosol-generating device for heating the aerosol-generating article.

The aerosol-generating article may be substantially cylindrical in shape. The aerosol-generating article may be substantially elongate. The aerosol-forming substrate may be substantially cylindrical in shape. The aerosol-forming substrate may be substantially elongate.

The aerosol-generating article may have a total length between approximately 30 mm and approximately 100 mm. The aerosol-generating article may have an external diameter between approximately 5 mm and approximately 12 mm. The aerosol-forming substrate may have a length of between approximately 10 mm and approximately 18 mm. Further, the diameter of the aerosol-forming substrate may be between approximately 5 mm and approximately 12 mm. The aerosol-generating article may comprise a filter plug. The filter plug may be located at the downstream end of the aerosol-generating article. The filter plug may be a cellulose acetate filter plug. The filter plug is approximately 7 mm in length in one embodiment, but may have a length of between approximately 5 mm to approximately 12 mm.

In one embodiment, the aerosol-generating article may have a total length of approximately 45 mm. The aerosol-generating article may have an external diameter of approximately 7.3 mm but may have an external diameter of between approximately 7.0 mm and approximately 7.4 mm. Further, the aerosol-forming substrate may have a length of approximately 12 mm. Alternatively, the aerosol-forming substrate may have a length of approximately 16 mm. The aerosol-generating article may comprise an outer paper wrapper. Further, the aerosol-generating article may comprise a separation between the aerosol-forming substrate and the filter plug. The separation may be approximately 21 mm or approximately 26 mm, but may be in the range of approximately 5 mm to approximately 28 mm. The separation may be provided by a hollow tube. The hollow tube may be a made from cardboard or cellulose acetate.

The aerosol-forming substrate may be a solid aerosol-forming substrate. Alternatively, the aerosol-forming substrate may comprise both solid and liquid components. The aerosol-forming substrate may comprise a tobacco-containing material containing volatile tobacco flavour compounds which are released from the substrate upon heating. Alternatively, the aerosol-forming substrate may comprise a non-tobacco material. The aerosol-forming substrate may further comprise an aerosol former. Examples of suitable aerosol formers are glycerine and propylene glycol.

If the aerosol-forming substrate is a solid aerosol-forming substrate, the solid aerosol-forming substrate may comprise, for example, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise comminuting one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

Although reference is made to solid aerosol-forming substrates above, it will be clear to one of ordinary skill in the art that other forms of aerosol-forming substrate may be used with other embodiments. For example, the aerosol-forming substrate may be a liquid aerosol-forming substrate. If a liquid aerosol-forming substrate is provided, the aerosol-generating device preferably comprises means for retaining the liquid. For example, the liquid aerosol-forming substrate may be retained in a container or a liquid storage portion. Alternatively or in addition, the liquid aerosol-forming substrate may be absorbed into a porous carrier material. The porous carrier material may be made from any suitable absorbent plug or body, for example, a foamed metal or plastics material, polypropylene, terylene, nylon fibres or ceramic. The liquid aerosol-forming substrate may be retained in the porous carrier material prior to use of the aerosol-generating device or alternatively, the liquid aerosol-forming substrate material may be released into the porous carrier material during, or immediately prior to use. For example, the liquid aerosol-forming substrate may be provided in a capsule. The shell of the capsule preferably melts upon heating and releases the liquid aerosol-forming substrate into the porous carrier material. The capsule may optionally contain a solid in combination with the liquid.

Alternatively, the carrier may be a non-woven fabric or fibre bundle into which tobacco components have been incorporated. The non-woven fabric or fibre bundle may comprise, for example, carbon fibres, natural cellulose fibres, or cellulose derivative fibres.

According to an example of the present disclosure, there is provided a method of manufacturing a heater assembly for an aerosol-generating device. The method may comprise providing a first heater casing comprising an air inlet. The method may comprise providing a second heater casing comprising an aerosol outlet. The method may comprise providing a heating chamber for heating an aerosol-forming substrate. The method may comprise arranging the heating chamber such that it is in fluid communication with both the air inlet and the air outlet to define an airflow pathway through the heater assembly. The method may comprise arranging the heating chamber between the first and second heater casings. The method may comprise attaching the first and second heater casings to each other using a fastener. The fastener may be configured to exert an axial force on the first and second heater casings to urge axially opposing internal surfaces of the first and second heater casings into sealing engagement with respective axially opposing end surfaces of the heating chamber to seal the airflow pathway.

According to an example of the present disclosure, there is provided a method of manufacturing a heater assembly for an aerosol-generating device. The method comprising: providing a first heater casing comprising an air inlet; providing a second heater casing comprising an aerosol outlet; providing a heating chamber for heating an aerosol-forming substrate and arranging the heating chamber such that it is in fluid communication with both the air inlet and the air outlet to define an airflow pathway through the heater assembly; arranging the heating chamber between the first and second heater casings and attaching the first and second heater casings to each other using a fastener, the fastener being configured to exert an axial force on the first and second heater casings to urge axially opposing internal surfaces of the first and second heater casings into sealing engagement with respective axially opposing end surfaces of the heating chamber to seal the airflow pathway.

The method may further comprise applying an axial compressive force to the first and second heater casings prior to attaching the first and second heater casings to each other using the fastener. The compressive force may be between 100 newtons and 300 newtons, preferably the compressive force is about 200 newtons.

The heating chamber may be press-fit into a recess formed in an internal surface of the first heater casing.

The heating chamber may be press-fit into a recess formed in an internal surface of the second heater casing.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.
Example Ex1: A heater assembly for an aerosol-generating device, the heater assembly comprising: a first heater casing comprising an air inlet; a second heater casing comprising an aerosol outlet; a heating chamber for heating an aerosol-forming substrate, the heating chamber being in fluid communication with both the air inlet and aerosol outlet to define an airflow pathway through the heater assembly.
Example Ex2: A heater assembly according to Example Ex1, wherein the heating chamber is arranged between the first and second heater casings.
Example Ex3: A heater assembly according to Example Ex1 or Ex2, wherein the first and second heater casings are attached to each other by a fastener, the fastener being configured to exert an axial force on the first and second heater casings to urge axially opposing internal surfaces of the first and second heater casings into sealing engagement with respective axially opposing end surfaces of the heating chamber to seal the airflow pathway.
Example Ex4: A heater assembly according to any of Examples Ex1 to Ex3, wherein at least one of the first and second heater casings comprises an internal cavity which surrounds the heating chamber, and wherein a length of the heating chamber is greater than a length of the internal cavity in an unassembled state of the heater assembly.
Example Ex5: A heater assembly according to Example Ex4, wherein the length of the heating chamber is about 0.5 percent to about 8.5 percent longer than the internal cavity.
Example Ex6: A heater assembly according to Example Ex5, wherein the length of the heating chamber is about 1.0 percent to about 5.0 percent longer than the internal cavity.
Example Ex7: A heater assembly according to Example Ex6, wherein the length of the heating chamber is about 1.3 percent to about 3.1 percent longer than the internal cavity.
Example Ex8: A heater assembly according to any preceding example, wherein at least one of the first and second heater casings comprises a material having a tensile modulus of less than 6 gigapascals.
Example Ex9: A heater assembly according to Example Ex8, wherein at least one of the first and second heater casings comprises a material having a tensile modulus of less than 5 gigapascals.
Example Ex10: A heater assembly according to Example Ex9, wherein at least one of the first and second heater casings comprises a material having a tensile modulus of less than 4 gigapascals.
Example Ex11: A heater assembly according to any preceding example, wherein at least one of the first and second heater casings comprises a polymer.
Example Ex12: A heater assembly according to any preceding example, wherein at least one of the first and second heater casings comprises a chamfer arranged at an internal surface of the at least one of the first and second heater casings for axially aligning the heating chamber.
Example Ex13: A heater assembly according to any preceding example, wherein the fastener comprises a threaded fastener.
Example Ex14: A heater assembly according to any of Examples Ex1 to Ex12, wherein the fastener comprises a snap-fit fastener.
Example Ex15: A heater assembly according to any preceding example, wherein the heater assembly comprises a plurality of fasteners.
Example Ex16: A heater assembly according to Example Ex15, wherein the plurality of fasteners are symmetrically spaced around an outer perimeter of the first and second heater casings.
Example Ex17: A heater assembly according to any preceding example, wherein the first heater casing, the second heater casing and the heating chamber each comprise an airflow channel, the airflow channels communicating to define the airflow pathway.
Example Ex18: A heater assembly according to any preceding example, wherein the heating chamber comprises a tubular heating chamber.
Example Ex19: A heater assembly according to Example Ex18, wherein a diameter of the tubular heating chamber at each end of the tubular heating chamber is greater than a diameter of the tubular heating chamber in a region between the two ends of the tubular heating chamber.
Example Ex20: A heater assembly according to Example Ex18 or Ex19, wherein each end of the tubular heating chamber is flared or funnel-shaped.
Example Ex21: A heater assembly according to Example Ex20, wherein an axial length of the flared or funnel-shaped end of the tubular heating chamber is between 0.5 percent and 10 percent of the overall length of the tubular heating chamber.
Example Ex22: A heater assembly according to Example Ex18 or Ex19, wherein each end of the tubular heating chamber has a stepped or joggled profile.
Example Ex23: A heater assembly according to Example Ex22, wherein an axial length of the stepped or joggled end of the tubular heating chamber is between 0.5 percent and 10 percent of the overall length of the tubular heating chamber.
Example Ex24: An aerosol-generating device comprising: a heater assembly according to any of the preceding claims; and a power supply for supplying electrical power to the heater assembly.
Example Ex25: A method of manufacturing a heater assembly for an aerosol-generating device, the method comprising: providing a first heater casing comprising an air inlet; providing a second heater casing comprising an aerosol outlet; providing a heating chamber for heating an aerosol-forming substrate and arranging the heating chamber such that it is in fluid communication with both the air inlet and the air outlet to define an airflow pathway through the heater assembly; arranging the heating chamber between the first and second heater casings; attaching the first and second heater casings to each other using a fastener, the fastener being configured to exert an axial force on the first and second heater casings to urge axially opposing internal surfaces of the first and second heater casings into sealing engagement with respective axially opposing end surfaces of the heating chamber to seal the airflow pathway.
Example Ex26: A method according to Example Ex25, further comprising applying an axial compressive force to the first and second heater casings prior to attaching the first and second heater casings to each other using the fastener.

Examples will now be further described with reference to the figures in which:

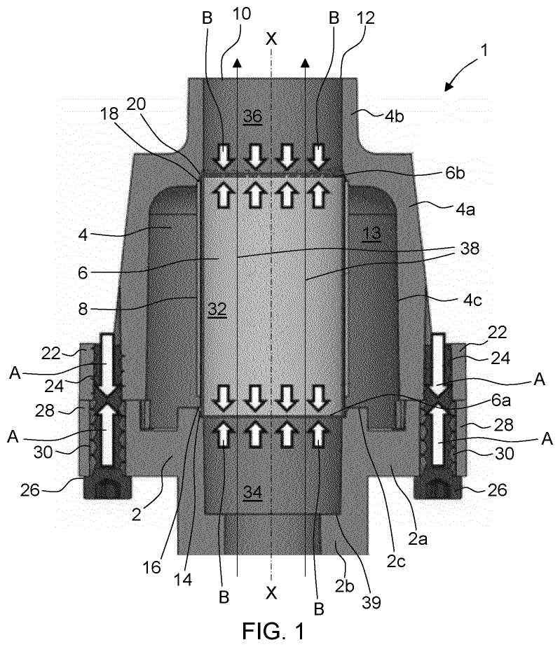

FIG. 1 is a longitudinal cross-section of a heater assembly according to an example of the present disclosure.

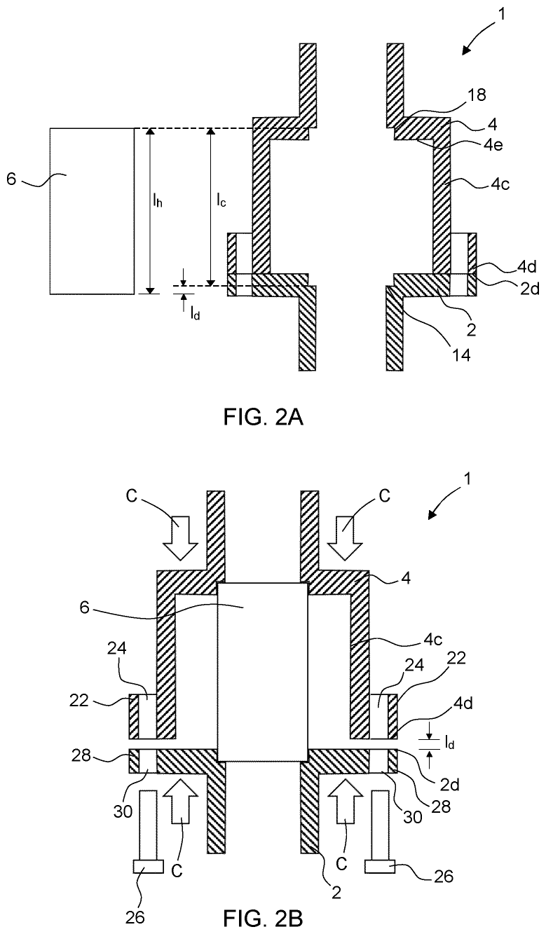

FIG. 2A is a schematic longitudinal cross-sectional view of the heater assembly of FIG. 1 in an unassembled state with heating chamber located outside of the heater casings.

FIG. 2B is a schematic longitudinal cross-sectional view of the heater assembly of FIG. 1 immediately prior to assembly with the heating chamber located inside the heater casings.

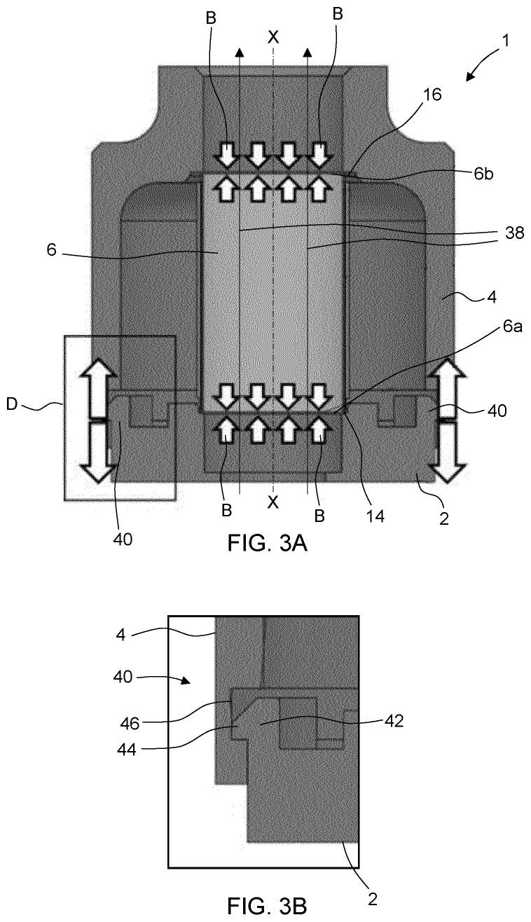

FIG. 3A is a longitudinal cross-section of a heater assembly according to another example of the present disclosure.

FIG. 3B is an enlarged view of the part of the heater assembly contained in the box labelled D in FIG. 3A.

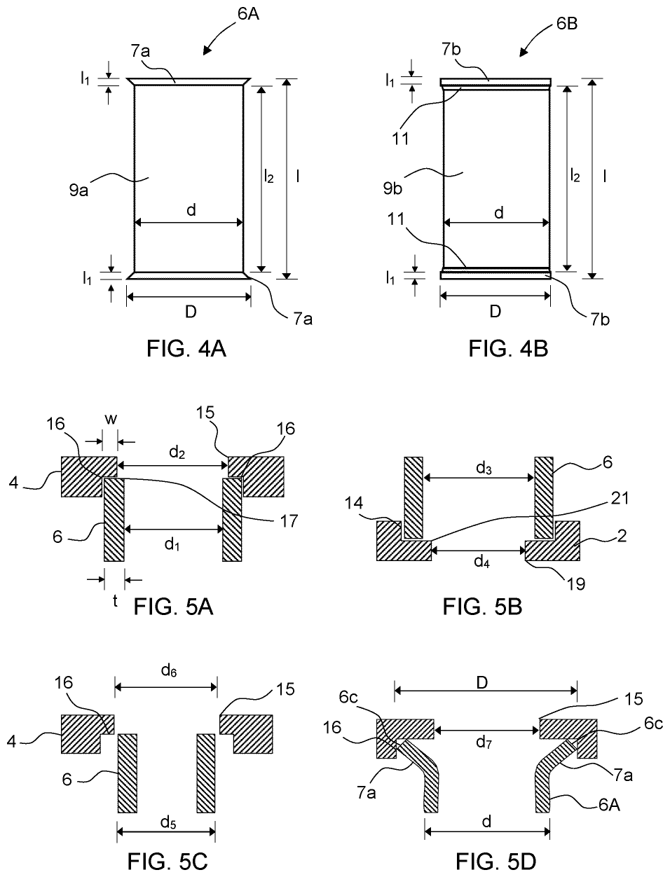

FIGS. 4A and 4B are side views of two example heating chambers for use in a heater assembly according to the present disclosure.

FIGS. 5A to 5C are schematic cross-sectional partial views of known tubular heating chambers showing problems which can occur due to manufacturing tolerances as a result of press-fitting of heating chambers into a heater casing.

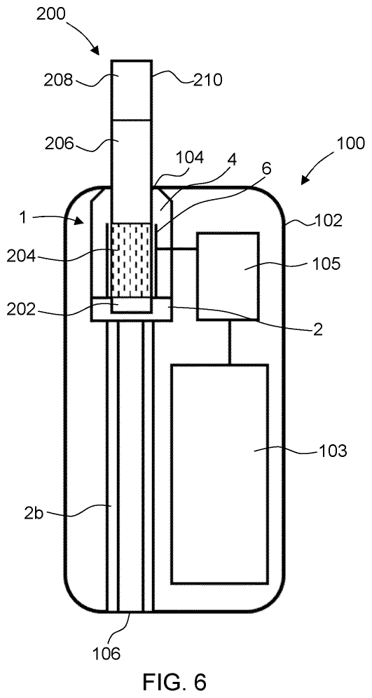

FIG. 6 is a schematic cross-sectional view showing the interior of an aerosol-generating device according to an example of the present disclosure and an aerosol-generating article received within the aerosol-generating device.

Referring to FIG. 1, this shows a longitudinal cross-section of a heater assembly 1 comprising a first heater casing 2, a second heater casing 4 and a heating chamber 6 for heating an aerosol-forming substrate. The first heater casing 2 comprises a substantially flat support section 2a and a first tubular section 2b. The support section 2a of the first heater casing 2 has an internal surface 2c which faces the second heater casing 4. An air inlet (not shown) is arranged at a distal end of a first tubular section 2b, which first tubular section 2b extends distally away from the support section 2a in a direction parallel to a longitudinal axis X-X of the heater assembly 1.

The second heater casing 4 comprises a hollow shell section 4a and a second tubular section 4b. The hollow shell section 4a has an internal cavity 4c that surrounds the heating chamber 6 and is open at its distal end to allow the heating chamber to be received within the internal cavity 4c. The internal cavity 4c of the hollows shell section 4a is closed at its distal end by the internal surface 2c of the support section 2a of the first heater casing 2. An aerosol outlet 10 is arranged at a proximal end of the second tubular section 4b, which second tubular section 4b extends proximally away from the hollow shell section 4a in a direction parallel to a longitudinal axis X-X of the heater assembly 1. The aerosol outlet 10 is defined by an opening 12 which is configured to receive an aerosol-generating article (not shown). Aerosol exits the opening 10 via an aerosol-generating article received in the heating chamber 6.

The heating chamber 6 comprises a tubular heating chamber made from stainless steel tubing. A heating element 8 is arranged around an exterior surface of the heating chamber to heat the heating chamber 6, which in turn heats an aerosol-forming substrate (not shown) received within an internal space of the tubular heating chamber 6. The heating element comprises heat-resistant flexible polyimide film having electrically resistive heating tracks (not shown) formed in a serpentine pattern on the film. The resistive heating tracks are connected to an electrical power supply (not shown) and generate heat when an electric current is passed through them. The heating element is arranged around substantially the entire length of the tubular heating chamber 6 to heat substantially the entire length of the tubular heating chamber 6.

The heating chamber 6 is supported on the support section 2a of the first heater casing 2. A distal or first end 6a of the heating chamber 6 is press-fit within a first recess 14 formed in the internal surface 2c of the first heater casing 2. An inner circumferential edge of the recess 14 has a slope or chamfer 16 for located the heating chamber 6 in the recess 14 and correctly aligning the heating chamber 6 relative to a longitudinal axis X-X of the heater assembly 1. A proximal or second end 6b of the heating chamber 6 is press-fit within a second recess 18 formed in an internal surface of the internal cavity 4c of the second heater casing 4. An inner circumferential edge of the recess 18 has a slope or chamfer 20 for located the heating chamber 6 in the recess 18 and correctly aligning the heating chamber 6 relative to a longitudinal axis X-X of the heater assembly 1. The second recess 18 is arranged axially opposite the first recess 14 in a direction parallel to the longitudinal axis X-X of the heater assembly 1.

The first 2 and second 4 heater casings are attached to each other and enclose the heating chamber 6. A distal end of the second heater casing 4 has two bosses or connecting blocks 22 arranged diametrically opposite each other on an external surface of the second heater casing 4. Each boss 22 has a hole 24 for receiving a screw 26. Two bosses or connecting blocks 28 are arranged at a proximal end of the first heater casing 2 at corresponding locations to boxes 22. Each of bosses 28 has a hole 30 for receiving the screw 26. To attach the first 2 and second 4 heater casings, a proximal end of the first heater casing 2 is brought into engagement with a distal end of the second heater casing 4 and the screw 26 is inserted through holes 24 and 30 to hold the first 2 and second 4 heater casings in engagement. The screw 26 therefore acts as a fastener holding the first 2 and second 4 heater casings in engagement with each other.

The sidewall of the internal cavity 4c of the second heater casing 4 is radially spaced from the heating chamber 6 to define a hollow airspace 13 around the heating chamber 6. The hollow airspace 13 helps to thermally insulate the heating chamber 6 which helps to reduce heat losses from the heating chamber 6 and also helps to reduce heat transfer to an exterior of the heater assembly 1 and aerosol-generating device.

The first 2 and second 4 heater casings are made from polyether ether ketone (PEEK) due to its advantageous heat-insulating and mechanical properties. PEEK has a lower thermal conductivity than the stainless steel tubular heating chamber 6 and this helps to reduce heat transfer or losses through the first 2 and second 4 heater casings. It also helps to maintain an external surface of the heater assembly 1 at a lower temperature than the external surface of the heating chamber 6. Furthermore, it helps to retain heat within the heating chamber to improve aerosol generation.

Another advantage of PEEK is that it has a tensile or Young's modulus less than that of stainless steel. The tensile modulus of PEEK is typically in the range of about 3.7 gigapascals to about 3.95 gigapascals, whereas the tensile modulus of stainless steel is typically in the range of 190 gigapascals to 203 gigapascals, although these values can vary depending on the particular composition of each material. These values mean that, when a force is applied to the heater assembly 1, the first 2 and second 4 heater casings will elastically deform in preference to the heating chamber 6 because the heating chamber is stiffer than the first 2 and second 4 heater casings. Such preferential elastic deformation has been found to be surprisingly advantageous for the heater assemblies of the present disclosure, as discussed in more detail below.

The tubular heating chamber 6 is arranged between first 2 and second 4 heater casings. The tubular heating chamber 6 has a length which is slightly longer (0.5 to 8.5 percent longer) than the length of the internal cavity 4c in the second heater casing 4 (including the depth of the second 16 recess in second heater casing 4 and the depth of the first recess 14 in the first heater casing 2). The difference in length between the heating chamber 6 and the internal cavity 4c is not visible in the assembled state of the heater assembly as shown in FIG. 1 but the difference in length is shown and discussed in more detail below with respect to FIGS. 2A and 2B. When the first 2 and second 4 heater casings are attached to one another around the heating chamber 6, the slightly longer and stiffer heating chamber 6 causes the first 2 and second 4 heater casings to elastically deform when their respective ends are brought into engagement. The first 2 and second 4 heater casings are maintained in their elastic deformed state by the screws 26 holding the first 2 and second 4 heater casings in engagement with each other. The screws 26 exert an axial force (denoted by arrows A in FIG. 1) on the first 2 and second 4 heater casings in a direction parallel to the longitudinal axis X-X of the heater assembly 1. The axial force urges the internal surfaces of the first 14 and second 16 recesses into sealing engagement with the end surfaces of the respective first 6a and second 6b ends of the heating chamber 6. The sealing engagement is the result of a compressive force (denoted by arrows B in FIG. 1) generated at the interface between the heating chamber 6 and first 2 and second 4 heater casings due to the axial force exerted by the screws 26. Localised plastic deformation of the first 2 and second 4 heater casings occurs in the region of the interface between the heating chamber 6 and first 2 and second 4 heater casings (that is, in the region between arrows B in FIG. 1) which assists in achieving a seal.

As mentioned above, the screws 26 are arranged diametrically opposite each other in their respective bosses 22, 28 on the external surfaces of the first 2 and second 4 heater casings. This symmetric arrangement of the screws with respect to the longitudinal axis X-X of the heater assembly 1 helps to apply a constant pressure between the end surfaces of the first 2 and second 4 heater casings which are in contact with each other around the entire circumference of the first 2 and second 4 heater casings. As a result of this constant pressure, a constant sealing pressure is created between the contact surfaces of the heating chamber 6 and first 2 and second 4 heater casings around the entire circumference of the tubular heating chamber 6.

The tubular heating chamber 6 has an airflow channel 32 defined by the internal space of the tubular heating chamber 6, which airflow channel 32 extends axially along the length of the heating chamber 6 in a direction parallel to a longitudinal axis X-X of the heater assembly 1. In addition, the first tubular section 2b of the first heater casing 2 has an airflow channel 34 and the second tubular section 4b of the second heater casing 4 has an airflow channel 36. The airflow channels 34, 32 and 36 of the first tubular section 2b, tubular heating chamber 6 and second tubular section 4b respectively are in fluid communication with each other to define an airflow pathway 38 through the heater assembly 1 between the air inlet (not shown) and the aerosol outlet 10. The heating chamber 6 is therefore in fluid communication with both the air inlet and the aerosol outlet 10.

The heating chamber 6 is axially aligned with the first 2b and second 4b tubular sections of the first 2 and second 4 heater casings respectively. Therefore, the axial force (denoted by arrows A in FIG. 1) exerted by the screws 26 assists in urging the heating chamber 6 and first 2 and second 4 heater casings into sealing engagement with each other to seal the airflow pathway 38 and reduce the likelihood of aerosol leaking out of the airflow pathway 38 at the points of intersection between the heating chamber 6 and first 2 and second 4 heater casings. Such sealing engagement is achieved as a result of the elastic deformation of the first 2 and second 4 heater casings without the use of polymer seals. Therefore, this arrangement helps to reduce the likelihood of undesirable by-products being released.

The first heater casing 2 has a step or stop 39 formed in an internal surface of the first tubular section 2b within its airflow channel 34. The stop 39 is arranged to engage a distal end of an aerosol-generating article (not shown) to inhibit movement of the distal end of the aerosol-generating article beyond the stop 28 and to accurately locate the aerosol-forming substrate provided within the aerosol-generating article within the heating chamber 6.

FIG. 2A shows a schematic longitudinal cross-sectional view of the heater assembly 1 of FIG. 1 in an unassembled state. For clarity, the tubular heating chamber 6 is shown outside of the first 2 and second 4 heater casings. The first 2 and second 4 heater casings are shown with the distal end 4d of the second heater casing touching the proximal end 2d of the first heater casing 2 but without any elastic deformation of the first 2 and second 4 heater casings. The axial length Iₕ of the tubular heating chamber 6 is greater than the axial length I_{c} of the internal cavity 4c by a length difference I_{d}. In this example, the length I_{c} of the internal cavity 4c includes the depth of the recesses 14 and 18 formed in the first 2 and second 4 heater casings and is measured from an upper or proximal flat internal surface of the recess 18 in the second heater casing 4 to a lower or distal flat internal surface of the recess 14 in the first heater casing 2. The internal surfaces of the recesses 14 and 18 form part of the internal surface of the first 2 and second 4 heater casings respectively.

It will be appreciated that some example heater assemblies may not use recesses to locate the heating chamber 6 and may just rely on the axial force exerted by the screws 26 in FIG. 1 to hold the heating chamber in place. In such an arrangement, the length I_{c} of the internal cavity will simply be the length of the internal cavity 4c of the second heater casing 4, that is, the axial length from the distal end 4d of the second heater case to the internal surface of an upper or proximal end wall 4e of the second heater casing.

FIG. 2B is a schematic longitudinal cross-sectional view of the heater assembly 1 of FIG. 1 immediately prior to assembly. The heating chamber 6 is located inside the internal cavity 4c of the second heater casing and located axially between the first 2 and second 4 heater casings. Due to the length difference I_{d} between the tubular heating chamber 6 and the internal cavity 4c, the distal end 4d of the second heater casing 4 is spaced apart from the proximal end 2d of the first heater casing 2 by a distance I_{d}.

To assemble the heater assembly 1, a compressive force (denoted by arrows C in FIG. 2B) of about 200 newtons is applied to the heater assembly 1. The compressive force C urges the distal end 4d of the second heater casing into engagement with the proximal end 2d of the first heater casing 2 and closes the space or gap between the first 2 and second 4 heater casings. The longer, stiffer heating chamber 6 causes the first 2 and second 4 heater casings to elastically deform, as described above. Screws 26 are then inserted into the holes 24, 30 formed in bosses 22, 28 whilst compressive force C is being applied and tightened to hold the first 2 and second 4 heater casings in engagement. The compressive force C is then removed. The screws 26 maintain the elastic deformation in the first 2 and second 4 heater casings once the compressive force C has been removed. As a result, the screws 26 exert an axial force on the first 2 and second 4 heater casings, as described above, to hold the first 2 and second 4 heater casings in sealing engagement with the tubular heating chamber 6.

It should be noted that FIGS. 2A and 2B are schematic and are not to scale. For clarity, the figures have been simplified by omitting some detail and altering or exaggerating the size of features.

FIG. 3A is a longitudinal cross-section of a heater assembly 1 according to another example of the present disclosure. The construction of the heater assembly 1 in FIG. 3A is identical to that in FIG. 1 with the exception that the first 2 and second 4 heater casings are attached to each other using a snap-fit connector 40 instead of the screw 26 and boss 22, 28 arrangement of FIG. 1.

Similar to the screws 26 in FIG. 1, the snap-fit connectors 40 maintain the first 2 and second 4 heater casings in their elastic deformed state and hold the first 2 and second 4 heater casings in engagement with each other. The snap-fit connectors 40 exert an axial force on the first 2 and second 4 heater casings in a direction parallel to the longitudinal axis X-X of the heater assembly 1. The axial force resists the elastic deformation of the first 2 and second 4 heater casings which would otherwise cause the first 2 and second 4 heater casings to come out of engagement. The axial force urges the internal surfaces of the first 14 and second 16 recesses into sealing engagement with the end surfaces of the respective first 6a and second 6b ends of the heating chamber 6, thereby sealing the airflow pathway 38. The sealing engagement is the result of a compressive force (denoted by arrows B in FIG. 3A) generated at the interface between the heating chamber 6 and first 2 and second 4 heater casings due to the axial force exerted by the snap-fit connectors 40. Localised plastic deformation of the first 2 and second 4 heater casings occurs in the region of the interface between the heating chamber 6 and first 2 and second 4 heater casings (that is, in the region between arrows B in FIG. 3A), which assists in achieving a seal.

Similar to the screws 26 in FIG. 1, the snap-fit connectors 40 are arranged diametrically opposite each other on the external surfaces of the first 2 and second 4 heater casings. This symmetric arrangement of the snap-fit connectors with respect to the longitudinal axis X-X of the heater assembly 1 helps to apply a constant pressure between the end surfaces of the first 2 and second 4 heater casings which are in contact with each other around the entire circumference of the first 2 and second 4 heater casings. As a result of this constant pressure, a constant sealing pressure is created between the contact surfaces of the heating chamber 6 and first 2 and second 4 heater casings around the entire circumference of the tubular heating chamber 6.

FIG. 3B is an enlarged view of one of the snap-fit connectors 40 of the heater assembly 1 contained in the box labelled D in FIG. 3A. The snap-fit connector 40 comprises a cantilever 42 and a ratchet 44. The ratchet 44 is arranged at a proximal end of the cantilever 42. The cantilever 44 and ratchet 44 are integrally formed with the first heater casing 2 at an edge of a proximal side of the first heater casing 2. The snap-fit connector 40 further comprises a slot 46 formed in an internal surface of the second heater casing 4 near to the distal end of the second heater casing 4. The slot 46 is configured to receive the ratchet 44. The ratchet 44 has a sloped leading edge and the cantilever 42 is able to elastically deform to allow the ratchet to pass into the internal cavity of the second heater casing 4 and into the slot 46. The ratchet 44 has a square trailing edge which prevents removal of the ratchet 44 from the slot 46 once the ratchet 44 has been received in the slot 46.

As can be seen from FIG. 3A, the snap-fit connector 40 reduces the dimensions of the heater assembly 1 because there is no need for the screw and boss arrangement of FIG. 1. The snap-fit connectors also help to achieve balanced alignment of the heater assembly components because they each apply the same amount of axial force. Furthermore, they help to simplify manufacture by only requiring a single press-fit operation to attach the first 2 and second 4 heater casings and reduce the number of parts required for attachment.

FIGS. 4A and 4B are side views of two example heating chambers for use in a heater assembly according to the present disclosure. Referring to FIG. 4A, this shows a first example heating chamber 6A. The heating chamber 6A comprises a stainless steel tube having a circular cross-section. A hollow internal space within the tubular heating chamber 6A has an internal diameter substantially corresponding to an external diameter of an aerosol-generating article so that the tubular heating chamber 6A can receive an aerosol-generating article (not shown) within the internal space. A portion 7a of the heating chamber 6A at each end of the heating chamber 6A is flared outwards to form a funnel shape at each end of the heating chamber 6A. The flared portions 7a each have a length I₁ and the percentage of the overall length I of the heating chamber 6A made up by each length I₁ of the flared portions may be in the range between 1 and 5 percent. The flared end portions 7a of the heating chamber 6A each form an angle of about 45 degrees with the longitudinal axis of the heating chamber 6A. As a result of the flared end portions 7a, the external diameter D at the two ends of the heating chamber 6A is larger than the external diameter d of the heating chamber 6A in between the two flared end portions 7a.

A portion 9a of the heating chamber 6A in between the two flared end portions 7a has straight sides, which are parallel to the longitudinal axis of the heating chamber 6A. The straight portion 9a of the heating chamber 6A has a length I₂, which substantially corresponds to the length of an aerosol-forming substrate provided in an aerosol-generating article configured to be received within the heating chamber 6A. Substantially all of the length I₂ of the straight portion 9a of the heating chamber 6A is circumscribed by a flexible heating element (not shown but described above in relation to FIG. 1). The flared portions 7a of the heating chamber 6A are not circumscribed by the heating element and act as spacers between the ends of the heating element and the components which hold the heating chamber 6A, that is, the first and second heater casings, and help to prevent direct contact between these components and the heating element.

Referring to FIG. 4B, this shows a second example heating chamber 6B. The heating chamber 6B has essentially the same construction as the heating chamber 6A in FIG. 4A with the exception that, instead of flared end portions, heating chamber 6B has stepped or joggled end portions 7b. That is, a portion 7b of the heating chamber 6B at each end of the heating chamber 6B is stepped or joggled radially outwards to form a step at each end of the heating chamber 6B. The stepped portions 7b each have a length I₁ and the percentage of the overall length I of the heating chamber 6B made up by each length I₁ of the stepped portions may be in the range between 1 and 5 percent. As a result of the stepped end portions 7b, the external diameter D at the two ends of the heating chamber 6B is larger than the external diameter d of the heating chamber 6B in between the two stepped end portions 7b.

A portion 9b of the heating chamber 6B in between the two stepped end portions 7b has straight sides, which are parallel to the longitudinal axis of the heating chamber 6B. The straight portion 9b of the heating chamber 6B has a length I₂, which substantially corresponds to the length of an aerosol-forming substrate provided in an aerosol-generating article configured to be received within the heating chamber 6B. Substantially all of the length I₂ of the straight portion 9b of the heating chamber 6B is circumscribed by a flexible heating element (not shown but described above in relation to FIG. 1). The stepped portions 7b of the heating chamber 6B are not circumscribed by the heating element and act as spacers between the ends of the heating element and the components which hold the heating chamber 6B, that is, the first and second heater casings, and help to prevent direct contact between these components and the heating element. The heating chamber 6B also comprises a transition portion 11 in between each stepped portion 7b and the straight portion 9b to provide a sloped or curved transition between the external diameter D of each stepped portion and the external diameter d of the straight portion.

FIGS. 5A to 5C are schematic cross-sectional views of parts of known tubular heating chambers having straight tubular walls showing problems which can occur due to manufacturing tolerances during the press-fitting of such heating chambers into engagement with a heater casing. Manufacturing tolerances can result in the dimensions of components being bigger or small than the specified design length, which can lead to problems with connecting close-fitting components. Achieving very precise manufacturing tolerances is more challenging in rapid manufacturing techniques such as injection moulding.

Referring to FIG. 5A, this shows an upper part of a known or conventional tubular heating chamber 6 press-fitted into a recess 16 in an upper heater casing 4. The entire length of the tubular heating chamber 6 is straight, that is, it has a constant outside diameter along its entire length, and the tubular heating chamber 6 does not have a flared or stepped end portion like the tubular heating chambers 6A and 6B in FIGS. 4A and 4B. As can be seen in FIG. 5A, the internal diameter d₁ of the heating chamber 6 is less than the internal diameter d₂ of an opening 15 in the heater casing 4 through which an aerosol-generating article passes during insertion of the aerosol-generating article into the heating chamber 6. As a result, part of the thickness t of each of the walls, that is, an end surface, of the heating chamber 6 protrudes into the internal space defined by internal diameter d₂ of the opening 15. This forms a sharp step 17 at the opening 15 which may damage an aerosol-generating article when an aerosol-generating article is inserted through opening 15 or may prevent the aerosol-generating article from being inserted. A similar situation may arise if the width w of the recess 16 is less than the thickness t of the walls of the tubular heating chamber 6. In this case, there is not sufficient space within recess 16 to receive the ends of the tubular heating chamber 6 and consequently the ends will protrude into the internal space defined by internal diameter d₂ of the opening 15.

It will be appreciated that a similar situation to that shown in FIG. 5A may arise at a lower or upstream end of the tubular heating chamber 6. Sharp steps at an upstream end of the heating chamber may suffer the problem that debris or deposits build up in the crevices formed by the step, which can be difficult to remove or clean with a cleaning tool.

FIG. 5B shows a lower part of a known or conventional tubular heating chamber 6 press-fitted into a recess 14 of a lower heater casing 2. As in FIG. 5A, the entire length of the tubular heating chamber 6 is straight. The internal diameter d3 of the heating chamber 6 is greater than an internal diameter d4 of an opening 19 formed in the lower heater casing 2 through which a portion of the aerosol-generating article protrudes when an aerosol-generating article is properly located in the heating chamber 6. As a result a sharp step 21 is formed at the opening 19 which may damage an aerosol-generating article when an aerosol-generating article is passes through opening 19 or may prevent the aerosol-generating article from being fully inserted.

It will be appreciated that a similar situation to that shown in FIG. 5B may arise at an upper or downstream end of the tubular heating chamber 6. Sharp steps at a downstream end of the heating chamber may suffer the problem that debris or deposits build up in the crevices formed by the step, which can be difficult to remove or clean with a cleaning tool.

FIG. 5C shows an upper part of a known or conventional tubular heating chamber 6 which is to be press-fitted into a recess 16 in an upper heater casing 4. As in FIGS. 5A and 5C, the entire length of the tubular heating chamber 6 is straight. The external diameter d5 of the tubular heating chamber 6 is less than the internal diameter of an opening 15 in the heater casing 4 through which an aerosol-generating article passes during insertion of the aerosol-generating article into the heating chamber 6. As a result, a press-fit is not possible in this situation because the tubular heating chamber 6 would simply pass through the opening 15.

FIG. 5D is a schematic cross-sectional view of an upper part of the tubular heating chamber 6A of FIG. 4A. As described above, the tubular heating chamber 6A has walls with a funnel-shaped or flared end portion 7a. The flared end portion 7a has been press-fitted into a recess 16 of the second heater casing 4. The external diameter D of the flared end portion 7a is larger than the external diameter d of the part of the tubular heating chamber 6A between the two flared end portions 7a (only one flared end portion is visible in FIG. 5D). The external diameter D of the flared end portion 7a is also larger than the internal diameter d₇ of an opening 15 in the heater casing 4 through which an aerosol-generating article passes during insertion of the aerosol-generating article into the heating chamber 6. The external diameter D of the flared end portion 7a is larger than the internal diameter d₇ of the opening 15 even when the radial or lateral manufacturing tolerances of the internal diameter d₇ are taken into account.

The arrangement of FIG. 5D significantly reduces the likelihood of a part of the end surfaces 6c of the walls of the tubular heating chamber 6A protruding within diameter d₇ and the airflow pathway cross-section which is defined in FIG. 5D by the diameter d₇. Furthermore, the end surfaces 6c of the walls of the tubular heating chamber 6A are angled away from the airflow pathway cross-section defined by the diameter d₇, which further reduces the likelihood of a part of the end surfaces 6c of the walls of the tubular heating chamber 6A protruding into the airflow pathway. The arrangement of FIG. 5D and, in particular, the use of a tubular heating chamber 6A with flared or funnel-shaped end portions 7a, allows for the use of components with greater radial or lateral tolerances and is therefore suited to rapid manufacturing techniques. The arrangement of FIG. 5D also significantly reduces the risk of damage to the aerosol-generating article upon insertion of the aerosol-generating article into the heating chamber 6A.

It will be appreciated that the tubular heating chamber 6B of FIG. 4B could also be used in the arrangement of FIG. 5D instead of heating chamber 6A to achieve the same benefits. The larger external diameter D at the stepped end portions 7b of heating chamber 6B reduces the likelihood of a part of the end surfaces of the walls of the tubular heating chamber 6B protruding within diameter d₇ of FIG. 5D and into the airflow pathway. The heating chamber 6B also allows for the use of components with greater radial or lateral tolerances and reduces the risk of damage to the aerosol-generating article upon insertion of the aerosol-generating article into the heating chamber 6B.

It should be noted that FIGS. 5A to 5D are schematic and are not to scale. For clarity, the figures have been simplified by omitting some detail and altering or exaggerating the size of features.

FIG. 6 is a schematic cross-sectional view showing the interior of an aerosol-generating device 100 and an aerosol-generating article 200 received within the aerosol-generating device 100. Together, the aerosol-generating device 100 and aerosol-generating article 200 form an aerosol-generating system. In FIG. 6, the aerosol-generating device 100 is shown in a simplified manner. In particular, the elements of the aerosol-generating device 100 are not drawn to scale. Furthermore, elements that are not relevant for the understanding of the aerosol-generating device 100 have been omitted.

The aerosol-generating device 100 comprises a housing 102, which may contain the heater assembly 1 of either FIG. 1 or FIG. 3A, a power supply 103 and control circuitry 105. In FIG. 6, the first heater casing 2, heating chamber 6 and second heater casing 4 are shown. As described above in relation to FIG. 1, the heating chamber 6 has a flexible heating element (not shown) arranged around it for heating the heating chamber 6. The power supply 103 is a battery and, in this example, it is a rechargeable lithium ion battery. The control circuitry 105 is connected to both the power supply 103 and the heating element and controls the supply of electrical energy from the power supply 103 to the heating element to regulate the temperature of the heating element.

The housing 102 comprises an opening 104 at a proximal or mouth end of the aerosol-generating device 100 through which an aerosol-generating article 200 is received. The opening 104 is connected to the opening 12 in the heater assembly 1 of FIG. 1, via which aerosol exits the heater assembly 1. However, it will be appreciated that aerosol largely exits the heater assembly 1 and the aerosol-generating device 100 via the aerosol-generating article 200. The housing 102 further comprises an air inlet 106 at a distal end of the aerosol-generating device 100. The air inlet 106 is connected to the air inlet arranged at a distal end of the first tubular section 2b of the first heater casing 2. The first tubular section 2b delivers air from the air inlet 106 to the heating chamber 6.

The aerosol-generating article 200 comprises an end plug 202, an aerosol-forming substrate 204, a hollow tube 206, a mouthpiece filter 208. Each of the aforementioned components of the aerosol-generating article 100 is a substantially cylindrical element, each having substantially the same diameter. The components are arranged sequentially in abutting coaxial alignment and are circumscribed by an outer paper wrapper 210 to form a cylindrical rod. The aerosol-forming substrate 204 is a tobacco rod or plug comprising a gathered sheet of crimped homogenised tobacco material circumscribed by a wrapper (not shown). The crimped sheet of homogenised tobacco material comprises glycerine as an aerosol-former. The end plug 202 and mouthpiece filter 208 are formed from cellulose acetate fibres.

A distal end of the aerosol-generating article 200 is inserted into the aerosol-generating device 100 via the opening 104 in the housing 102 and pushed into the aerosol-generating device 100 until it engages a stop (not shown in FIG. 6) arranged in the second heater casing 4, at which point it is fully inserted. The stop helps to correctly locate the aerosol-forming substrate 204 within the heating chamber 6 so that the heating chamber 6 can heat the aerosol-forming substrate 204 to form an aerosol.

The aerosol-generating device 100 may further comprise: a sensor (not shown) for detecting the presence of the aerosol-generating article 200; a user interface (not shown) such as a button for activating the heating element; and a display or indicator (not shown) for presenting information to a user, for example, remaining battery power, heating status and error messages.

In use, a user inserts an aerosol-generating article 200 into the aerosol-generating device 100, as shown in FIG. 6. The user then starts a heating cycle by activating the aerosol-generating device 100, for example, by pressing a switch to turn the device on. In response, the control circuitry 105 controls a supply of electrical power from the power supply 103 to the heating element (not shown) to heat the heating element, which in turn heats the heating chamber 6. During a heating cycle, the heating element heats the heating chamber 6 to a predefined temperature, or to a range of predefined temperatures according to a temperature profile. A heating cycle may last for around 6 minutes. The heat from the heating chamber 6 is transferred to the aerosol-forming substrate 204 which releases volatile compounds from the aerosol-forming substrate 204. The volatile compounds form an aerosol within an aerosolisation chamber formed by the hollow tube 206. During a heating cycle, the user places the mouthpiece filter 208 of the aerosol-generating article 200 between the lips of their mouth and takes a puff or inhales on the mouthpiece filter 208. The generated aerosol is then drawn through the mouthpiece filter 102 into the mouth of the user.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5 percent (5%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-22. (canceled)

23. A heater assembly for an aerosol-generating device, the heater assembly comprising:
a first heater casing comprising an air inlet;
a second heater casing comprising an aerosol outlet; and
a heating chamber configured to heat an aerosol-forming substrate, the heating chamber being in fluid communication with both the air inlet and aerosol outlet to define an airflow pathway through the heater assembly,
wherein the heating chamber is arranged between the first and the second heater casings, and
wherein the first and the second heater casings are attached to each other by a fastener, the fastener being configured to exert an axial force on the first and the second heater casings to urge axially opposing internal surfaces of the first and the second heater casings into sealing engagement with respective axially opposing end surfaces of the heating chamber to seal the airflow pathway.

24. The heater assembly according to claim 23,
wherein at least one of the first and the second heater casings further comprises an internal cavity that surrounds the heating chamber, and
wherein a length of the heating chamber is greater than a length of the internal cavity in an unassembled state of the heater assembly.

25. The heater assembly according to claim 24, wherein the length of the heating chamber is 0.5 percent to 8.5 percent longer than the internal cavity.

26. The heater assembly according to claim 23, wherein the first and the second heater casings are directly attached to each other by the fastener.

27. The heater assembly according to claim 23, wherein the axially opposing end surfaces of the heating chamber are in direct engagement with the respective axially opposing internal surfaces of the first and the second heater casings.

28. The heater assembly according to claim 23, wherein at least one of the first and the second heater casings further comprises a material having a tensile modulus of less than 6 gigapascals.

29. The heater assembly according to claim 23, wherein at least one of the first and the second heater casings further comprises a polymer.

30. The heater assembly according to claim 23, wherein at least one of the first and the second heater casings further comprises a chamfer arranged at an internal surface of the at least one of the first and the second heater casings for axially aligning the heating chamber.

31. The heater assembly according to claim 23, wherein the fastener comprises a threaded fastener or a snap-fit fastener.

32. The heater assembly according to claim 23, wherein the first and the second heater casings are attached to each other by a plurality of fasteners.

33. The heater assembly according to claim 32, wherein the plurality of fasteners are symmetrically spaced around an outer perimeter of the first and the second heater casings.

34. The heater assembly according to claim 23, wherein the first heater casing, the second heater casing and the heating chamber each comprise an airflow channel, the airflow channels communicating to define the airflow pathway.

35. The heater assembly according to claim 23, wherein the heating chamber comprises a tubular heating chamber.

36. The heater assembly according to claim 35, wherein a diameter of the tubular heating chamber at each end of the tubular heating chamber is greater than a diameter of the tubular heating chamber in a region between said each end of the tubular heating chamber.

37. The heater assembly according to claim 35, wherein said each end of the tubular heating chamber is flared or funnel-shaped.

38. The heater assembly according to claim 35, wherein said each end of the tubular heating chamber has a stepped or joggled profile.

39. The heater assembly according to claim 23, wherein the heating chamber is configured to receive at least a portion of an aerosol-generating article.

40. An aerosol-generating device, comprising:
a heater assembly according to claim 23; and
a power supply configured to supply electrical power to the heater assembly.

41. A method of manufacturing a heater assembly for an aerosol-generating device, the method comprising:
providing a first heater casing comprising an air inlet;
providing a second heater casing comprising an aerosol outlet;
providing a heating chamber for heating an aerosol-forming substrate and arranging the heating chamber such that the heating chamber is in fluid communication with both the air inlet and the air outlet to define an airflow pathway through the heater assembly;
arranging the heating chamber between the first and the second heater casings; and
attaching the first and the second heater casings to each other using a fastener, the fastener being configured to exert an axial force on the first and the second heater casings to urge axially opposing internal surfaces of the first and the second heater casings into sealing engagement with respective axially opposing end surfaces of the heating chamber to seal the airflow pathway.

42. The method according to claim 41, further comprising applying an axial compressive force to the first and the second heater casings prior to attaching the first and the second heater casings to each other using the fastener.
